(19) United States
(12) Patent Application Publication
(10) Pub. No.: US 2023/0404030 A1
(43) Pub. Date: Dec. 21, 2023

(54) Water Trough Cleaner

(71) Applicants: Shula Davis, Clovis, CA (US); Lillian Frankian, Clovis, CA (US)

(72) Inventors: Shula Davis, Clovis, CA (US); Lillian Frankian, Clovis, CA (US)

(21) Appl. No.: 17/841,492

(22) Filed: Jun. 15, 2022

(51) Int. Cl. A01K 7/02; C02F 1/00; B01D 29/90; B01D 35/02

(52) U.S. Cl. CPC A01K 7/02; C02F 1/001; B01D 29/902; B01D 35/02; C02F 2103/20

(57) ABSTRACT

The water trough cleaner is the only product of its kind that has the capability of removing all loose hay from the water trough without requiring users to completely dump quality water out as a consequence of separation. This unprecedented device is uniquely designed with durable materials and advanced technology to ensure complete functionality and long-term sustainability.

### BACKGROUND

Cleaning water troughs to remove loose hay is often regarded as one of the most challenging, time-consuming, and labor intensive chores when managing a stable. Along with the grimy mess in the trough, it can also be really hard and heavy to dump the water out without wasting quality water that horses could have access to, if the process was simplified. There have been no products available as original equipment or as an aftermarket to address this problem.

An apparatus to simplify the process of cleaning water trough's without wasting quality water is not being met by any known device or system at present. There have been no products available as original equipment or as an aftermarket to address this problem either.

### SUMMARY OF THE INVENTION

The main purpose of the water trough cleaner is to provide users with a device that facilitates removing loose hay from water troughs in an effective manner.

A water trough cleaning device comprising a chassis configured to travel in the water trough and have a bottom and sides configured to travel proximal a bottom and sides of the water trough. The disclosure includes an auger on a bottom of the chassis. The disclosure also includes a filter configured to allow a water in the trough to flow to pass there through and to separate a hay from the water flow.

### BRIEF DESCRIPTION OF THE DRAWINGS

FIG. 1 is a top perspective view of the water trough cleaner in accordance with an embodiment of the present disclosure

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

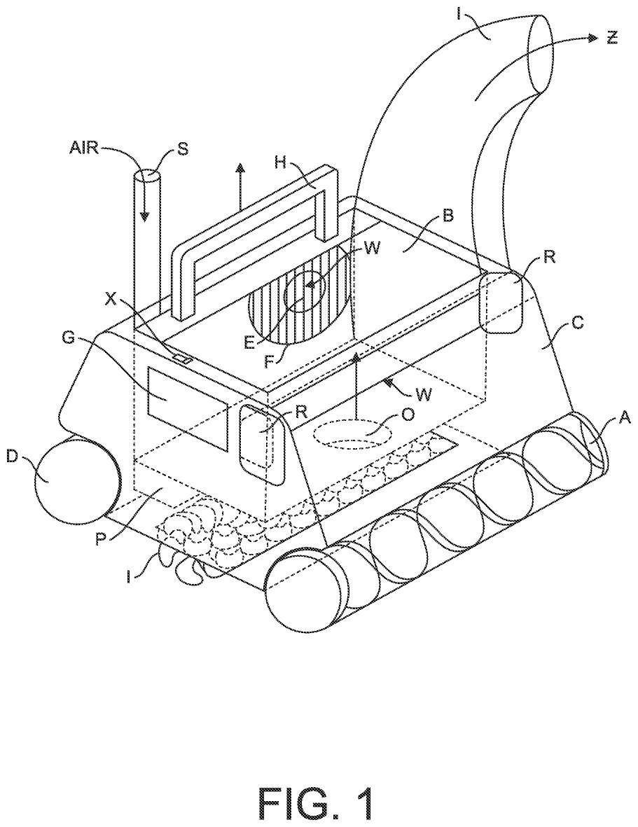

FIG. 1 is a top perspective view of the water trough cleaner showing: an auger A, a removable holding tank referenced as B, a chassis C, wheels D, water egress E, a filter F, a water proof battery G, a handle H to the chassis and/or to the holding tank B, a hay impeller I, a water ingress orifice O in the chassis bottom, a pump P, a roller bumper R, a snorkel air intake S, a water flow W, an electrical switch X and a hay throw Z which is directional in embodiments in accordance with the present disclosure.

The present disclosed water trough cleaner, also known as the “Water Trough Cleaner” offers a modern approach to water management that completely eliminates the need for individuals to dump out the heavy water trough while removing the loose hay and therefore allows easier operation. Expanding on the initial design of an average water trough, the water trough cleaner introduces a novel cleaning device that effectively removes all loose hay from the water trough via the use of a suctioning vacuum and a removable filter that serves to separate disposable contents from running water. The unit will offer three (3) cleaning options, ranging from light to turbo, and will overall provide a device that ensures a fully operational cleaning medium able to thoroughly filter water in order to provide the cleanest water for horses to utilize. This innovating, top-quality product may benefit all individuals who seek to have a more convenient, time-efficient and simple means of ensuring their water troughs are clean.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A water trough cleaning device comprising:
a chassis configured to travel in the water trough and have a bottom and sides configured to travel proximal a bottom and sides of the water trough;
an auger on a bottom of the chassis; and
a filter configured to allow a water in the trough to flow to pass there through and to separate a hay from the water flow.

2. The device of claim 1, further comprising a pump configured to pressurize the passing of the water through the filter.

3. The device of claim 1, further comprising a water ingress opening defined in the chassis.

4. The device of claim 1, further comprising a water egress opening defined in the chassis.

5. The device of claim 1, further comprising a water proof battery configured to power a pump for the water flow.

6. The device of claim 1, further comprising a removable holding tank within the chassis configured for holding the separated hay.

7. The device of claim 1, wherein the auger composes a plurality of foam blades.

8. The device of claim 1, further comprising a plurality of wheels disposed on the bottom of the chassis.

9. The device of claim 1, further comprising a bumper roller for each side of the chassis configured to enable a passage of the chassis through the water trough.

10. The device of claim 1, further comprising a handle on the chassis and configured to enable a user to push the device through the trough.

11. The device of claim 1, further comprising a portable hay holding tank with a handle configured to enable a user to withdraw the hay holding tank from the chassis.

12. The device of claim 1, further comprising a hay impeller configured to propel the hay through the chassis.

13. The device of claim 1, further comprising a hay throw chute configured to direct a hay discharge from the chassis.

14. The device of claim 1, further comprising a snorkel air intake in communication with the chassis and configured to provide an air flow into the chassis.

15. The device of claim 1, further comprising an impeller second stage of a hay separation and discharge from the chassis.
